(19) United States
(12) Patent Application Publication
(10) Pub. No.: US 2006/0088321 A1
(43) Pub. Date: Apr. 27, 2006

(54) Closed loop RZ-DPSK alignment for optical communications

(76) Inventors: Peter Y. Cheung, Chino Hills, CA (US); James R. Dupont, Lomita, CA (US); Lauriston C. Wah, Manhattan Beach, CA (US); Gilbert Yu, Rancho Palos Verdes, CA (US)

Correspondence Address: Norman E. Carte;MacPHERSON KWOK CHEN & HEID LLP, Suite 226, 1762 Technology Drive, San Jose, CA, 95110, US

(21) Appl. No.: 10/973,857

(22) Filed: Oct. 25, 2004

(51) Int. Cl. H04B 10/04

(52) U.S. Cl. 398/195

(57) ABSTRACT

A method and system are provided for using a power spectral density of an output of a modulator to facilitate closed loop feedback for controlling alignment of a pulse with respect to information formed upon the pulse.

### STATEMENT REGARDING FEDERALLY SPONSORED RESEARCH OR DEVELOPMENT

This invention was made with Government support. The Government has certain rights in this invention.

### TECHNICAL FIELD

The present invention relates generally to modulator circuits for optical communications and, more particularly, to an RZ-DPSK optical modulator that uses close loop feedback to automatically maintain desired timing alignment of an RZ pulse carver with respect to a DPSK modulator.

### BACKGROUND

Modulators for optical communications are well known. Modulators superimpose information upon a carrier, so that the information may be communicated by transmitting the modulated carrier to a distant location. In optical communications, information such as data or voice is superimposed upon a laser beam.

There are many methods for modulating a laser beam for communications. One example of such a method is RZ-DPSK (return-to-zero differential phase-shift keying).

According to DPSK, a change of phase of an RF (radio frequency) data signal that is superimposed upon the carrier indicates one of two possible bit states (it indicates that the bit is a one, for example). The change of phase is with respect to some predetermined reference phase. Conversely, no change of phase of the data signal indicates the other bit state (it indicates that the bit is a zero, for example).

The duration of an individual data signal is referred to as the bit period. Thus, the bit period is that portion of the DPSK modulated signal where phase indicates the bit state for a single bit.

According to the RZ (return-to-zero) aspect of RZ-DPSK, the data signal rides atop an intensity (voltage) modulated RF (radio frequency) pulse that defines where each bit is located in the data stream. Since this pulse is an intensity modulated RZ pulse, the voltage level of the pulse returns to zero voltage between successive bits.

RZ-DPSK provides enhanced receiver sensitivity when compared to ON-OFF keying (OOK) modulation techniques. Thus, RZ-DPSK is a preferred modulation technique for optical communications.

However, for optimum performance of an RZ-DPSK system, it is essential to locate the peak of each intensity modulated RZ pulse near the middle of its associated bit period. Proper alignment of the bit periods with respect to the RZ pulses is necessary for reliable demodulation.

The intensity modulated RZ pulses are formed by an RZ carver. DPSK modulation is performed by a DPSK modulator. The timing of the RZ carver must be properly aligned with respect to the timing of the DPSK modulator in order for the peak of the intensity modulated RZ pulses to be positioned near the middle of the bit periods.

Time delays associated with the optical and electrical devices of a modulator can drift over time due to such factors as temperature and aging of components. These time delays determine, at least in part, the alignment of the RZ carver with respect to the DPSK modulator. Thus, misalignment can occur as the RZ-DPSK modulator changes temperature and/or ages.

At high data rates, such as data rates greater than 40 Gbps, such misalignment can become appreciable relative to the bit period and, if not corrected, can result in significant performance degradation.

Thus, it is desirable to achieve acceptable modulator performance by monitoring the timing alignment between the RZ pulse carver and the DPSK modulator during RZ-DPSK modulator operation and by making continuous timing adjustments so as to maintain desired timing alignment.

### SUMMARY

Systems and methods are disclosed herein that substantially maintain a desired time alignment between an RZ pulse carver and a DPSK data modulator during operation thereof. For example, in accordance with one aspect of the present invention, a power spectral density of an output of an RZ-DPSK modulator is monitored and used to determine alignment of the timing of an RZ carver with respect to the timing of a DPSK modulator.

More specifically, in accordance with one aspect of the present invention, closed loop feedback is provided by monitoring a power spectral density of an output of an RZ-DPSK modulator and a delay circuit is used to vary the relative timing of an RZ carver and a DPSK modulator with respect to one another. A delay of a clock signal and/or data signal is varied in a manner that tends to align the bit period defined by the DPSK modulator with respect to the peak of the intensity modulated pulse defined by the RZ carver, such that the peak of the intensity modulated pulse is positioned proximate the middle of the bit period.

In accordance with another aspect of the present invention, a photodetector receives an optical output of the RZ-DPSK modulator and converts the optical output to an electrical signal representative thereof. An RF detector detects the power of the radio frequency electrical signal. Control electronics process the detected RF signal to determine a power spectral density thereof. The power spectral density is used to vary a time delay of the RZ carver and/or the DPSK modulator, so as to vary the relative timing between the RZ carver and the DPSK modulator.

In accordance with another aspect of the present invention, a band pass filter reduces the presence of undesirable frequency components and selects specific desirable frequency components in the electrical signal provided to the RF detector and an integrator averages the RF detected signal over time.

Thus, in accordance with one aspect of the present invention, acceptable RZ-DPSK modulator performance is maintained by making continuous timing adjustments so as to provide desired alignment between the RZ pulse carver and the DPSK modulator. In this manner, the reliability of the subsequent demodulation process is substantially enhanced.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a block diagram illustrating a modulator system that uses closed loop feedback control of the relative timing of a RZ carver and a DPSK modulator in accordance with one embodiment of the present invention.

FIG. 2 shows two power spectral density spectra for a transition time of 4 picoseconds, wherein the lower spectrum is for a time misalignment of the RZ carver and the DPSK modulator of 0.0 picoseconds (ideal alignment) and the upper spectrum is for a time misalignment of 12.5 picoseconds (substantially misaligned), and wherein both spectra were formed via a computer simulation.

FIG. 3 shows two power spectral density spectra for a transition time of 8 picoseconds, wherein the lower spectrum is for a time misalignment of the RZ carver and the DPSK modulator of 0.0 picoseconds (ideal alignment) and the upper spectrum is for a time misalignment of 12.5 picoseconds (substantially misaligned), and wherein both spectra were formed via a computer simulation.

FIG. 4 shows a communication system comprising a transmitter having a modulator system and also comprising a receiver, according to one aspect of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

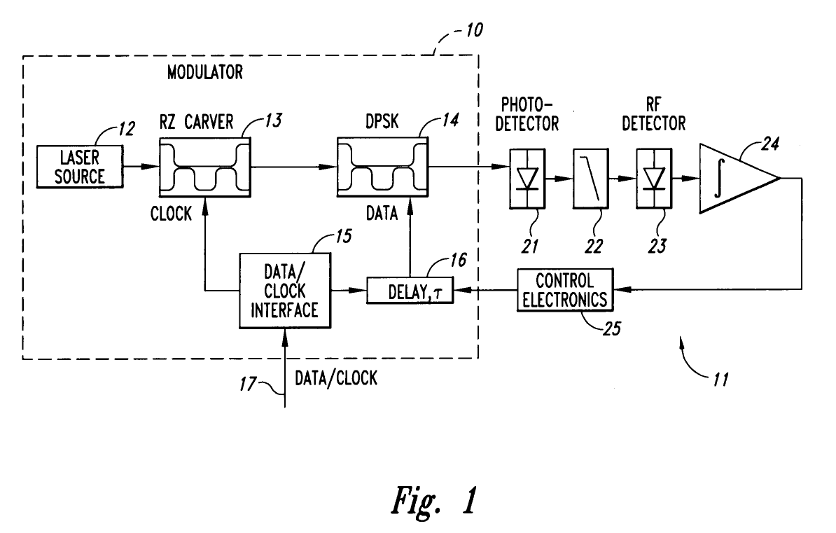

FIG. 1 shows a closed loop modulator system comprising an RZ-DPSK modulator 10 and a feedback loop 11 according to one embodiment of the invention. RZ-DPSK modulator 10 comprises a laser source 12 that can provide light to an RZ carver 13. Laser source 12 can be any laser or combination of lasers that are suitable for optical communications, including fixed wavelength lasers, tunable wavelength lasers, visible light lasers and infrared lasers.

An RZ carver may be any electrical circuit, optical device, other mechanism and/or combination thereof that is capable of modulating a light beam or the like to form a pulse thereon. For example, RZ carver 13 can comprise one or more Mach-Zehnder interferometers.

RZ carver 13 forms an intensity modulated RZ pulse on the light from laser source 12 and provides the intensity modulated RZ pulse to a DPSK modulator 14. DPSK modulator 14 forms one bit of phase modulated information upon each intensity modulated RZ pulse. Thus, RZ carver 13 and DPSK modulator 14 cooperate to perform RZ-DPSK modulation according to well known principles.

A DPSK modulator may be any electrical circuit, optical device, other mechanism and/or combination thereof that is capable of modulating a pulse with information according to the differential phase-shift keying technique. For example, DPSK modulator 14 can comprise one or more Mach-Zehnder interferometers.

Although, DPSK modulator 14 will typically form a single bit of information upon each intensity modulated RZ pulse, more that one bit of information may alternatively be formed upon a single pulse (such as to enhance communication bit rate), if desired. Conversely, a single bit can be spread among a plurality of pulses (such as to enhance communication reliability). Indeed, those skilled in the art will appreciate that any number of bits can be formed upon any number of pulses and that any number of pulses can be used to define any number of bits.

According to one aspect of the present invention, the information is modulated according to bi-phase differential phase-shift keying. However, those skilled in the art will appreciate that other forms of modulation are likewise suitable. For example, quadrature phase modulation and/or a combination of amplitude modulation and phase modulation may be used.

The data is formed upon the intensity modulated RZ pulse during a bit period. As discussed above, it is desirable that the bit period be aligned in time with the intensity modulated RZ pulse, such that the peak of the intensity modulated RZ pulse is in the middle of the bit period.

A data/clock interface 15 receives a data and clock signal 17. The clock signals can be used to time the formation of the intensity modulated RZ pulses by RZ carver 13. The data can be provided to DPSK modulator 14 so that it can be modulated onto the intensity modulated RZ pulses. A delay circuit 16 delays or advances the timing of the data as the data is communicated from data/clock interface 15 to DPSK modulator 14, so as to provide desired alignment of the bit period with respect to the peak of the intensity modulated pulse.

Laser source 12, RZ carver 13, DPSK modulator 14, data/clock interface 15, and delay circuit 16 thus cooperate to at least partially define RZ-DPSK modulator 10.

A feedback loop 11 receives at least a portion of the output of the RZ-DPSK modulator 10 and provides a control signal to delay circuit 16. The control signal varies the amount of time delay provided by delay circuit 16 such that the intensity modulated RZ pulse is maintained in desired alignment with respect to the bit period. That is, the control signal varies the time delay so as to enhance alignment of the peak of the intensity modulated RZ pulse with respect to the middle of the bit period.

A feedback loop may be any electrical circuit, optical device, other mechanism and/or combination thereof that receives information representative of alignment of an RZ carver or the like with respect to a DPSK modulator or the like and that also provides information that facilitates control of this alignment. For example, feedback loop 11 can comprise a variety of different components that process an optical output of RZ-DPSK modulator 10 and provide an electrical control signal that is dependent upon a characteristic of the optical output.

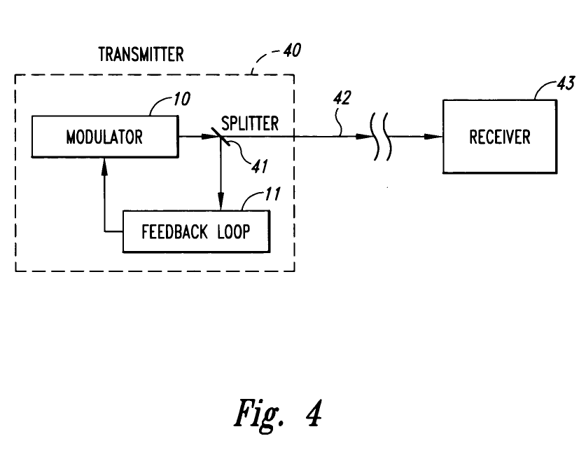

A beam splitter or other optical device may be used to provide a portion of the modulated light output from the RZ-DPSK modulator 10 to the feedback loop 11, as shown in FIG. 4 and discussed below. However, splitting of the modulated light output reduces the power of the beam that is used for data communications.

Alternatively, optical switching or the like may be used to provide substantially all of the modulated light output from the RZ-DPSK modulator 10 to the feedback loop 11 at desired times, such as periodically during use of the transmitter 40 (FIG. 4) and/or during periods when no data is being transmitted (such as by modulating the pulses with dummy data). The use of such time slicing of the modulated light output mitigates undesirable reduction in power of the modulated light, but may introduce time delays in data transmission that reduce the bit rate thereof. Any desired combination of beam splitting and time slicing may be used to provide desired results.

Referring back to FIG. 1, feedback loop 11 comprises a photodetector 21 that converts the optical output of RZ-DPSK modulator 14 into an electrical signal representative thereof. The electrical signal can be filtered by a band pass filter 22 and the filtered signal can then be provided to an RF detector 23.

Optionally, filtering the electrical signal reduces the amount of undesirable frequency components contained therein and thus enhance a subsequent RF detection process (such as by mitigating undesirable aliasing). Filtering also allows the selection of specific frequency components of the power spectral density that is subsequently used for the determination of misalignment. However, it should be appreciated that some RF detectors and/or other components of the feedback loop 11 may inherently be limited in response to the desired frequency band, thus reducing the need for such filtering.

RF detector 23 detects the power of an electrical signal and provides the detected signal to an integrator 24. Integrator 24 averages the detected signal and provides an integrated signal to control electronics 25. Control electronics 25 determines a power spectral density or some characteristic or combination of characteristics of a power spectral density of the output of integrator 24, as described in more detail below.

Integrator 24 tends to smooth fluctuations in the RF signal that may otherwise tend to cause the feedback loop 11 to perform erratically. Integrator 24 also accumulates sufficient signal to facilitate the use of power spectral density by control electronics 25.

The power spectral density can be used to form a control signal. Generally, higher power spectral densities indicate greater misalignment of the timing of RZ carver 13 with respect to DPSK modulator 14. The control signal can be provided to delay circuit 16. Delay circuit 16 varies the timing of the modulation of the intensity modulated RZ pulse with the data. That is, delay circuit 16 moves the bit period in time such that the peak of the intensity modulated RZ pulse tends to be approximately centered with respect to the bit period.

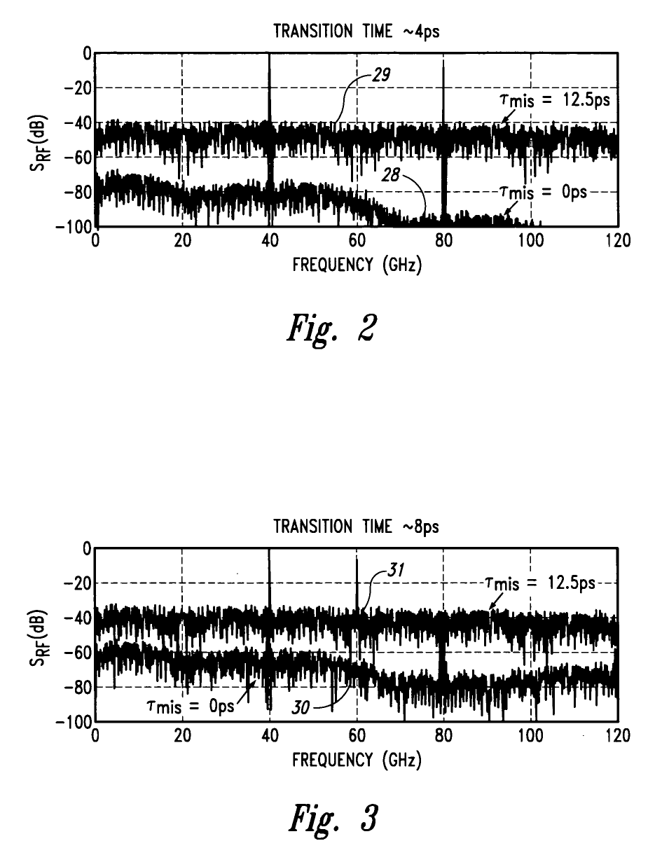

FIG. 2 shows two power spectral density charts that were generated during computer simulations of the present invention. A transition time of 4 picoseconds for the RZ pulse is used during these computer simulations. The lower chart shows a time misalignment of the RZ carver and the DPSK modulator of 0.0 picoseconds (ideal alignment) and the upper chart shows a time misalignment of 12.5 picoseconds (substantially misaligned).

FIG. 3 shows two more power spectral density charts that were generated during computer simulations of the present invention. A transition time of 8 picoseconds for the RZ pulse is used during these computer simulations. The lower chart shows a time misalignment of the RZ carver and the DPSK modulator of 0.0 picoseconds (ideal alignment) and the upper chart shows a time misalignment of 12.5 picoseconds (substantial misalignment).

It is clear from FIG. 2 and FIG. 3 that the power spectral density increases with greater misalignment of the timing of RZ carver 13 with respect to DPSK modulator 14. This appears to be the case over a range of RZ pulse transition times (and consequently over a range of corresponding bit rates and pulse widths). Control electronics 25 takes advantage of this characteristic of the power spectral densities to generate a control signal for the delay circuit 16.

Control electronics 25 of the present invention does not necessarily determine spectra having the resolution of FIG. 2 and FIG. 3. Rather, control electronics 25 merely needs to determine the comparative level of such spectra. For example, control electronics 25 may calculate selected portions or points of a spectrum or may calculate the area under the spectrum or some approximation of this area. Only a portion or portions of the frequency range shown in FIG. 2 and FIG. 3 may be utilized, if desired. Thus, the use of a power spectral density according to the present invention may comprise monitoring some selected characteristic of the power spectral density.

However, although the power spectral density of the RZ-DPSK modulator output indicates the amount of misalignment, it does not indicate the direction of the misalignment. Control electronics 25, according to one aspect of the present invention, are configured to monitor the power spectral density, detect the direction of misalignment, and generate a control signal that is expected to mitigate the misalignment, and monitor the power spectral density to determine if the assumed direction was correct.

One embodiment of control electronics 25 is the utilization of phase-sensitive dither control electronics. In this configuration, delay circuit 16 is being dithered or modulated by a small amplitude sinusoidal signal. The slight changes in RZ-DPSK alignment results in the generation of spectral dither sidebands. The phase of the dither sidebands depends on the direction of misalignment. Phase-sensitive technique is then used to detect the dither sidebands and to determine the direction of misalignment.

Alternatively, the RZ-DPSK modulator 10 may be configured or biased such that misalignment of the timing of RZ carver 13 with respect to DPSK modulator 14 only occurs in one direction. This may be accomplished, for example, by configuring the RZ-DPSK modulator such that expected temperature changes and component aging only cause the misalignment to occurring in one direction.

FIG. 4 shows a communication system comprising a transmitter 40 and a receiver 43. An optical conduit, such as an optical fiber 42, facilitates the transmission of information from transmitter 40 to receiver 43. Receiver 43 is typically located remotely with respect to transmitter 40 and can be located many miles therefrom. One or repeaters, multiplexers, demultiplexers, pulse shapers, timing correctors, dispersion correctors, and/or other processing devices may optionally be disposed along optical fiber 42.

Further, in some instances at least a portion of the optical conduit may be omitted. For example, a modulated laser beam may be transmitted in the air, in a vacuum (such as in space), or through some other transparent media without the use of an optical fiber or the like.

A splitter 41 can be used to facilitate separation of a portion of the RZ-DPSK modulated output of RZ-DPSK modulator 10 for use by feedback loop 11, as discussed above.

Timing or aligning the bit period with respect to intensity modulated pulse is the same as timing or aligning the intensity modulated pulse with respect to the bit period. The timing of either one may be varied so as to align it with the other. Thus, the timing of one or both may be varied so as to achieve the desired alignment.

The present invention, according to at least one aspect thereof, substantially maintains a timing alignment of a modulator such that performance of a communication system is enhanced and high data rates tend to be maintained.

Embodiments described above illustrate but do not limit the invention. It should also be understood that numerous modifications and variations are possible in accordance with the principles of the present invention. Accordingly, the scope of the invention is defined only by the following claims.

We claim:

1. An RZ-DPSK modulator system comprising a feedback loop, the feedback loop being configured to use power spectral density to align a pulse with data that is formed upon the pulse.

2. An RZ-DPSK modulator system comprising:
an RZ carver for forming an intensity modulated pulse;
a DPSK modulator receiving the intensity modulated pulse and forming a phase modulated signal thereon during a bit period; and
a feedback loop configured to use power spectral density of an output of the DPSK modulator to time align at least one of the bit period and the intensity modulated pulse such that a peak of the intensity modulated RZ pulse tends to be proximate a middle of the bit period.

3. The RZ-DPSK modulator system of claim 2, wherein the RZ carver comprises a Mach-Zehnder interferometer.

4. The RZ-DPSK modulator system of claim 2, wherein the DPSK modulator comprises a Mach-Zehnder interferometer.

5. The RZ-DPSK modulator system of claim 2, wherein the DPSK modulator comprises a bi-phase modulator.

6. The RZ-DPSK modulator system of claim 2, wherein the feedback loop comprises:
a photodetector in optical communication with the DPSK modulator;
an RF detector in electrical communication with the photodetector; and
control electronics in electrical communication with the RF detector, the control electronics providing an output that facilitates alignment of the bit period and the intensity modulated pulse.

7. The RZ-DPSK modulator system of claim 2, wherein the feedback loop comprises:
a photodetector in optical communication with the DPSK modulator;
a band pass filter in electrical communication with the photodetector;
an RF detector in electrical communication with the band pass filter;
an integrator in electrical communication with the RF detector; and
control electronics in electrical communication with the integrator, the control electronics providing an output that facilitates alignment of the bit period and the intensity modulated pulse.

8. The RZ-DPSK modulator system of claim 2, wherein the feedback loop comprises control electronics, the control electronics being configured to analyze at least a portion of an RF spectrum to facilitate alignment of the bit period and the intensity modulated pulse.

9. The RZ-DPSK modulator system of claim 2, wherein the feedback loop comprises control electronics, the control electronics being configured to minimize at least a portion of a power spectral density to facilitate alignment of the bit period and the intensity modulated pulse.

10. The RZ-DPSK modulator system of claim 2, further comprising a laser source that provides light to the RZ carver.

11. The RZ-DPSK modulator system of claim 2, wherein the data rate thereof is greater than 40 Gbps.

12. An RZ-DPSK modulator system comprising:
means for forming an intensity modulated pulse;
means for receiving the intensity modulated pulse and forming a phase modulated signal thereon during a bit period; and
means for using power spectral density of the phase modulated signal to time align at least one of the bit period and the intensity modulated pulse such that a peak of the intensity modulated RZ pulse tends to be proximate a middle of the bit period.

13. A transmitter comprising an RZ-DPSK modulator system, the RZ-DPSK modulator system comprising a feedback loop that is configured to use power spectral density of a modulator output to facilitate alignment of a pulse with respect to information formed onto the pulse.

14. A communication system comprising a transmitter and a receiver, the transmitter comprising an RZ-DPSK modulator system, the RZ-DPSK modulator system comprising a feedback loop that is configured to use power spectral density of a modulator output to facilitate alignment of a pulse with respect to information formed onto the pulse.

15. A method for performing modulation, the method comprising using a power spectral density of an output of an RZ-DPSK modulator to facilitate closed loop feedback for controlling alignment of a pulse with respect to information formed upon the pulse.

16. A method for performing RZ-DPSK modulation, the method comprising:
forming an intensity modulated pulse;
forming a phase modulated signal upon the intensity modulated pulse during a bit period; and
using power spectral density of the phase modulated pulse to vary a timing of at least one of the bit period and the intensity modulated pulse such that a peak of the intensity modulated RZ pulse tends to be proximate a middle of the bit period.

17. The method as recited in claim 16, wherein forming an intensity modulated pulse comprises RZ modulating a laser beam.

18. The method as recited in claim 16, wherein forming a phase modulated signal comprises DPSK modulating a laser beam.

19. The method as recited in claim 16, wherein using power spectral density to vary a timing of at least one of the bit period and the intensity modulated pulse comprises using power spectral density in a closed loop feedback system to align the bit period with respect to intensity modulated pulse.

20. The method as recited in claim 16, wherein using power spectral density to vary a timing of at least one of the bit period and the intensity modulated pulse comprises:
converting an optical output of a modulator into an electrical signal thereof;
RF detecting the electrical signal to form a detected signal; and
using the detected signal to form a power spectral density representative of the optical output of the modulator.

21. The method as recited in claim 16, wherein using power spectral density to vary a timing of at least one of the bit period and the intensity modulated pulse comprises:
converting an optical output of a modulator into an electrical signal thereof;
band pass filtering the electrical signal to form a filtered signal;
RF detecting the filtered signal to form a detected signal;
integrating the detected signal to form an integrated signal; and
using the integrated signal to form a power spectral density representative of the optical output of the modulator.

22. The method as recited in claim 16, wherein using power spectral density to vary a timing of at least one of the bit period and the intensity modulated pulse comprises using the power spectral density to vary a delay that varies a timing of the bit period.

23. The method as recited in claim 16, wherein using power spectral density to vary a timing of at least one of the bit period and the intensity modulated pulse comprises using the power spectral density to vary a delay that varies a timing of the intensity modulated pulse.

24. The method as recited in claim 16, wherein forming a phase modulated signal comprises bi-phase modulating an optical carrier.
